(19) United States
(12) Patent Application Publication
(10) Pub. No.: US 2011/0045233 A1
(43) Pub. Date: Feb. 24, 2011

(54) DIMENSIONAL CONTROL DURING FIRING TO FORM ALUMINUM TITANATE HONEYCOMB STRUCTURES

(76) Inventors: Sandra Lee Gray, Horseheads, NY (US); Daniel Edward McCauley, Watkins Glen, NY (US); Christopher John Warren, Waverly, NY (US)

Correspondence Address: CORNING INCORPORATED, SP-TI-3-1, CORNING, NY, 14831, US

(21) Appl. No.: 12/844,250

(22) Filed: Jul. 27, 2010

Related U.S. Application Data
(60) Provisional application No. 61/235,485, filed on Aug. 20, 2009.

(51) Int. Cl. B32B 3/12; B29C 47/92

(52) U.S. Cl. 428/116; 264/40.1

(57) ABSTRACT

A method for controlling the dimensional shrinkage or growth of AT honeycomb structures during the firing process by control of the alkali metal ion content in the AT-forming batch materials extruded into an AT green body structure that is heated to form the fired AT honeycomb structure.

### CROSS-REFERENCE TO RELATED APPLICATIONS

This application claims the benefit of priority under 35 U.S.C. §119(e) of U.S. Provisional Application Ser. No. 61/235,485 filed on Aug. 20, 2009.

### FIELD

The present disclosure is directed to a method for controlling the shrinkage, or growth, of honeycomb ware during firing to form aluminum titanate honeycomb structures by controlling the sodium content in the honeycomb ware, and to product made using the method.

### BACKGROUND

Aluminum titanate (“AT”) is a material of choice for various types of honeycomb structures or substrates that can selectively plugged and be used as, for example without limitation, diesel particulate filter traps [also called herein “DPF(s)”, “filter traps” or simply “filter(s)]. However, the ability to produce extrude-to-shape aluminum titanate honeycombs structures is dependent on the ability to minimize the variability in how much the honeycomb ware shrinks (or grows) during the sintering process as well as the stability of certain physical properties which determines it effectiveness as a filter. Because the plugged honeycomb structure is placed in a “housing” or “can” when it is used, there are certain requirements placed on the contour of the honeycomb. For example, a specification could require that the shrinkage (or growth) of the extruded and fired ware does not vary more than ±0.5% from the targeted value in order to insure that any particular mass-produced honeycomb would fit into any particular can. In some instances the variation can be no more then ±0.3% from the targeted value.

Some of the methods that have been reported to control the extent of shrinkage and physical property variability in honeycomb structures include calcining and/or milling/comminuting of the batch raw materials to a defined particle size distribution prior to extrusion into the honeycomb structure. For example, in SiC (silicon carbide) DPFs, it has been shown that altering the Si content alters the shrinkage behavior. Shrinkage and pore size distribution can be modified by controlled mixing of coarse and fine Al₂O₃ within the same composition (Taruta et al, “Influence of Aluminum Titanate Formation on Sintering of Bimodal Size-Distributed Alumina Powder Mixtures”, J. Am. Ceram. Soc., Vol. 80 (1997), pages 551-56). Pore size distribution (pore radius) can be modified through controlled changes in batch TiO₂ which alters the final stoichiometry (Wang et al, “Microstructure control of ceramic membrane support from corundum-rutile powder mixture”, Powder Technology, Vol. 168 (2006), pages 125-133). Another method of shrinkage management in aluminum titanate DPFs is to vary the size of the wet extruded part in order to compensate for the natural shrinkage variability caused by raw material and process variability. However, this method entails a severe limitation when an AT honeycomb is required to meet the stringent skin quality specifications that the commercially available cordierite substrates are required to meet, particularly when the AT honeycomb is intended for use in the light duty vehicle class of cars, vans and small trucks. In this case, the magnitude of inherent shrinkage variability in AT honeycombs is too large to use the same cordierite “skin former die cut” approach to form the substrate. “Skin former die cut” means a physical cut is made into the die which promotes a skin flow of higher quality but this “cut” is of a fixed size and requires an extrudate of extremely consistent size with low variability. For cordierite substrates one can vary the amount of SiO₂ in the batch (while properly compensating for other components) to keep shrinkage variability to a near constant. This same type of material variation is not possible for AT honeycombs because AT does not have multiple raw materials with shared cations, and the ratio of the alumina and titania used to form the fired honeycomb's aluminum titanate crystal structure must be tightly controlled.

### SUMMARY

In one aspect a method is disclosed herein for controlling the shrinkage or growth (green to fired) of honeycomb ware during firing by control of the alkali metal content (for example without limitation, the Na content) present in the AT batch materials used to form the honeycomb substrate. It has been found that careful control of the alkali metal content plays a significant role in altering the shrinkage or growth of the honeycomb. The primary sources of trace alkali metal levels, particularly Na, in the AT honeycombs is associated with the alumina (Al₂O₃) and hydroxypropyl methylcellulose that are used to prepare the AT honeycombs. While Al₂O₃ can be purchased with a range of Na impurity levels, the variation in Na content is also associated with a range of particle size distributions which effect AT properties, for example, pore size distribution. Decoupling these two changes, Na content and particle size distribution, and the individual effect they have on the physical properties of an AT honeycomb has been very difficult until the present discovery. Using pilot plant scale operations, the Na effect on physical properties (due to Na content of the batch materials) was specifically de-coupled from other effects, and it has been discovered that controlling the Na effect presents a novel method for controlling shrinkage in aluminum titanate substrates.

The method described herein is used for controlling the shrinkage or growth of a honeycomb structure between a green body state and a fired state, and it comprises the steps of:
(a) providing an AT-forming batch composition,
(b) extruding the batch composition into a green AT-forming honeycomb structure,
(c) measuring the dimensions (for example without limitation, the diameter of a cylindrical structure, or the major and minor axes of an oval structure) of the green structure,
(d) firing the green structure to form a fired AT honeycomb structure,
(e) measuring the dimensions (for example without limitation, the diameter of a cylindrical structure, or the major and minor axes of an oval structure) of the fired AT structure,
(f) determining the shrinkage or growth in the dimensions between the green structure and fired structure,
(g) adjusting the alkali salt content of the AT-forming batch composition by the addition of a selected amount of a selected alkali salt to the AT-forming batch composition, and
(h) repeating (a) to (g) as necessary to control the shrinkage or growth of the AT honeycomb between the green body and fired states.
   The alkali salts are selected from the group consisting of Li, Na, K, Rb, Cs salts, and the anion of the alkali salt is selected from the group consisting of chloride, bromide, iodide, bicarbonate, and carbonate. In one embodiment the alkali salt is added an aqueous solution and is selected from the group consisting of alkali metal chloride, bromide, iodide, bicarbonate, and carbonate salts. In one embodiment the method is directed to extruding of the batch composition into a green AT-forming honeycomb structure, the extruding of the batch composition being through a skin through a skin former die to co-form an AT honeycomb substrate having an integral skin.

The disclosure is also directed to an alumina titanate (AT) honeycomb, said honeycomb having a alkali metal ion content in the range of 0.1 wt % to 0.6 wt % greater than that of the total alkali metal ion content present in the raw materials used to make the AT-forming batch composition, the additional 0.1 wt % to 0.6 wt % alkali metal ion being added as a selected soluble alkali metal salt as described herein to the raw materials used to make the AT-forming batch composition. In one embodiment the alkali metal ion content is in the range of 0.1 wt % to 0.4 wt % greater than that of the total alkali metal ion content present in the raw materials used to form the AT-forming batch composition, the additional 0.1 wt % to 0.6 wt % alkali metal ion being added as a selected soluble alkali metal salt as described herein to the raw materials used to make the AT-forming batch composition. In another embodiment the alumina titanate honeycomb has a sodium ion content that is in the range of 0.1 wt % to 0.6 wt % greater than that of the total alkali metal ion content present in the raw materials used to form the AT-forming batch composition, the additional 0.1 wt % to 0.6 wt % sodium metal ion being added as a selected soluble sodium salt as described herein to the raw materials used to make the AT-forming batch composition. In a further embodiment the alumina titanate honeycomb has a sodium ion content that is in the range of 0.1 wt % to 0.4 wt % greater than that of the total alkali metal content present in the raw materials used to form the AT-forming batch composition, the additional 0.1 wt % to 0.6 wt % sodium metal ion being added as a selected soluble salt as described herein to the raw materials used to make the AT-forming batch composition.

### BRIEF DESCRIPTION OF THE DRAWINGS

FIG. 1 is a chart illustrating the green body to fired body shrinkage of 2 inch (˜5.1 cm) diameter extruded aluminum titanate honeycomb structures as a function of Na content.

FIG. 2 is a chart illustrating the porosity, measured by the mercury intrusion method, of 2 inch (˜5.1 cm) diameter extruded aluminum titanate honeycomb structures as a function of Na content.

FIG. 3 is a chart illustrating the median pore diameter, measured by the mercury intrusion method, of 2 inch (˜5.1 cm) diameter aluminum titanate honeycomb structures as a function of Na content.

FIG. 4 is a chart illustrating the coefficient of thermal expansion, measured at 800° C., of 2 inch (˜5.1 cm) diameter extruded aluminum titanate honeycomb structures as a function of Na content.

FIG. 5 is an enlarged view of a portion of a honeycomb extrusion die used in the “skin former die cut” method to co-extrude a honeycomb body with an integral skin.

### DETAILED DESCRIPTION

Disclosed herein is a method for controlling the shrinkage or growth honeycomb ware during firing to form aluminum titanate (AT) honeycomb structures, and in particular AT honeycomb structures having a plurality of channels from one end of the honeycomb structure to the other end. Such honeycomb structures can be used in a variety of applications such as membrane separations, flow-through catalytic converters and particulate filters for use on light and heavy duty vehicles, stationary engines, and other applications. A honeycomb structure can be unplugged, for example as a flow-through catalytic support, or can be plugged for use as a filter device. Also herein Na is used as an exemplary alkali metal whose content is adjusted. Na is the primary alkali metal contaminant. While herein the adjustments have been made using added Na, other alkali metal ions such as Li, K, Rb, and Cs can also be used to make the adjustment to control shrinkage or growth. Herein the phrase “AT-forming batch composition” means “a batch composition suitable for forming aluminum titanate honeycomb structures using a composition as may be described herein or in the references describing the preparation of aluminum titanate structures.”

The preparation of aluminum titanate structures is described in U.S. Pat. Nos. 4,483,944, 4,855,265, 5,290,739, 6,620,751, 6,942,713, 6,849,181, 7,001,861, 7,259,120, 7,294,164; U.S. Patent Application Publication Nos.: 2004/0020846 and 2004/0092381; and in PCT Application Publication Nos. WO 2006/015240, WO 2005/046840, and WO 2004/011386. The foregoing patents and patent publications disclose aluminum titanate structures and compositions, and are incorporated herein by reference.

In preparing the composition the batch materials include, in addition to the alumina and titania (added for example as powders), organic binder(s), pore forming agents, and may additionally include lubricants and selected liquids, for example without limitation, aqueous based liquids or liquid mixtures. The inorganic aluminum titanate ceramic-forming ingredients (for example without limitation, alumina, titania and other materials as indicated herein and in the cited art), the organic binder and the pore forming agent may be mixed together with a liquid to form the ceramic precursor batch. The liquid may provide a medium for the binder to dissolve, thus providing plasticity to the batch and wetting of the powders. The liquid may be aqueous based, which may normally be water or water-miscible solvents, or organically based. Aqueous based liquids can provide hydration of the binder and powder particles. In some embodiments the amount of liquid is from about 20% by weight to about 50% by weight.

Alumina titanate honeycombs comprise alumina (Al₂O₃) and titania (TiO₂) that are combined and processed to form the AT honeycombs. We have found that Na is a common impurity in commercially available alumina. It is also a common impurity in hydroxymethyl cellulose which can be used as a batching material. While alumina with different level of Na impurity can be purchased, different levels of Na are also associated with different alumina particle size distributions. The different alumina particle size distributions can affect properties of AT honeycomb structures, for example, the AT honeycomb structure's coefficient of thermal expansion (CTE), shrinkage rate during firing, and the pore size distribution. It has been found that that varying the amount of Na in the AT batch by after taking into account the Na present in the alumina as an impurity provides a method of controlling the shrinkage of AT structures without affecting other AT properties such as pore size distribution and coefficient of thermal expansion (CTE).

The Na (or other alkali metal) salt can be added as a solid to the batch materials when they are being mixed or it can be introduced as a solution, preferably an aqueous solution, after the batch materials have been added. When Na salts are used to adjust the shrinkage or growth rate of the ware formed from a given AT batch composition, it is preferable that the Na salt be added as an aqueous solution and mixed into the batch. The Na salt is preferably, but not limited to, a soluble salt selected from the group consisting of chloride, bromide, iodide, C₂-C₄ carboxylic acid, bicarbonate, silicate and carbonate salts. Additional alkali salts that can be used to adjust the shrinkage or growth include Li, K, Rb, Cs and mixtures there of, including Na-containing mixtures.

A number of exemplary AT batch compositions were prepared in which the amount of Na in the batches was varied. The batches were extruded using pilot scale extrusion equipment to form 2 inch (˜5.1 cm) honeycomb structures to quantify the impact of Na addition. The base Na impurity level of the alumina was ˜0.1%. An AT-forming batch composition was also made using the base alumina without further addition of Na. Three additional AT batch compositions were made using the base alumina with the addition of Na that was added as a NaI (sodium iodide) salt. The amounts of added NaI were sufficient to increase the amount of Na in the compositions over that in the base composition by 0.1 wt %, 0.2 wt % and 0.4 wt %. After firing the resulting four tested AT composition thus had a total Na amount of 0.1 wt %, 0.2 wt %, 0.3 wt %, and 0.5 wt %, respectively. Firing of the pilot plant parts was carried out at a temperature in the range of 1380° C. to 1450° C. for a time in the range of 8 to 24 hours. Multiple samples of the extruded parts and fired parts were measured to determine both shrinkage and physical properties. The following four figures illustrate the relationships between Na level and the corresponding property. The 0.1 wt % total Na parts are the control parts.

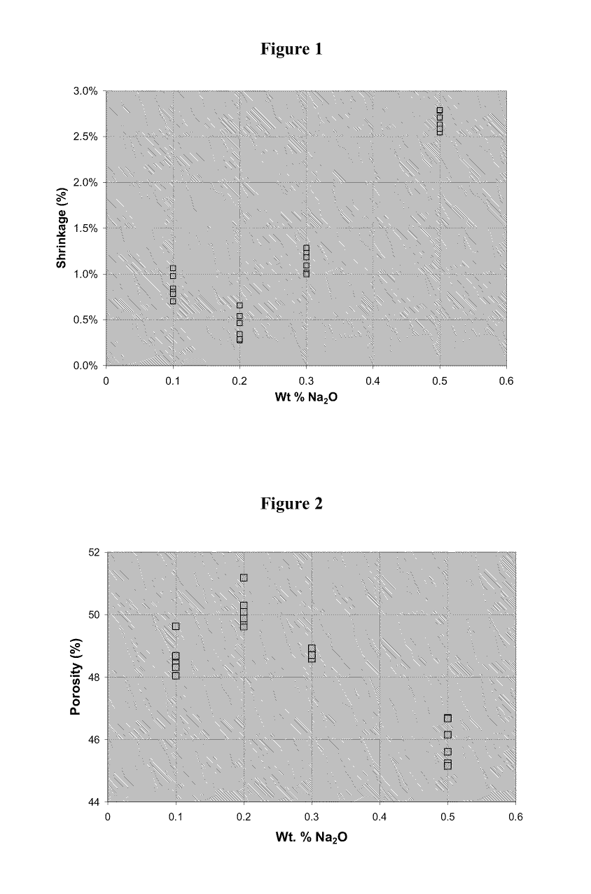

FIG. 1 is a chart illustrated the green body to fired shrinkage of 2 inch diameter extruded AT parts as a function of Na content. The chart shows that increasing the total Na content from 0.1 wt % to 0.2 wt % decreases the average shrinkage of the parts from approximately 0.8% to approximately 0.4%, an approximately 50% decrease in shrinkage. Further, increasing the total Na content to 0.3 wt % total Na increases the average shrinkage to approximately 1.2% which is about 20% greater than the control parts. Increasing the total Na content to 0.5 wt % increases the average shrinkage to approximately 2.7% which is approximately 330% higher than that of the control parts.

FIG. 2 is a chart illustrating the percent porosity, measured by the mercury intrusion method, of 2 inch (˜5.1 cm) diameter extruded aluminum titanate substrates as a function of Na content. The results indicate that when the total Na increased from 0.1 wt % to 0.2 wt % the total porosity rose from approximately 49% to approximately 51%. When the total Na content was further increased to 0.3 wt % the percent porosity returned to approximately 49%. Further increasing the total Na content to 0.5 wt % saw the percent porosity decrease to approximately 46%.

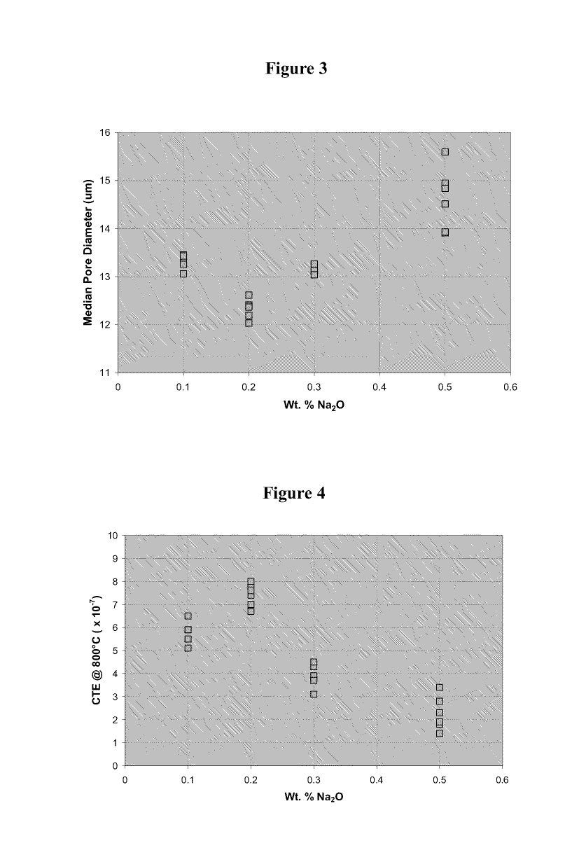

FIG. 3 is a chart illustrating the median pore diameter, measured by the mercury intrusion method, of 2 inch (˜5.1 cm) diameter aluminum titanate substrates as a function of Na content. The results indicate that when the total Na increased from 0.1 wt % to 0.2 wt % the median pore diameter of the product decreased from approximately 13.5 μm to approximately 12.5 μm. When the total Na content was further increased to 0.3 wt % the median pore diameter returned to approximately 13.5 μm. Further increasing the total Na content to 0.5 wt % saw the median pore diameter increase to approximately 14.8 μm.

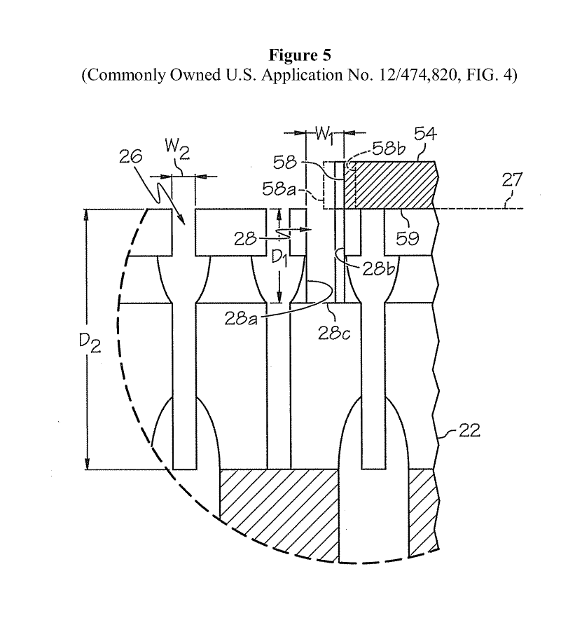

FIG. 4 is a chart illustrating the coefficient of thermal expansion (CTE), measured at 800° C., of 2 inch (˜5.1 cm) diameter extruded aluminum titanate substrates as a function of Na content. The results indicate that when the total Na increased from 0.1 wt % to 0.2 wt % the CTE product increased from approximately 5.8 to ppm/° 13.5 μm to approximately 12.5 μm. When the total Na content was further increased to 0.3 wt % the median pore diameter returned to approximately 13.5 μm. Further increasing the total Na content to 0.5 wt % saw the median pore diameter increase to approximately 14.8 μm.

FIGS. 1-4 show that the Na level of the AT batch composition has a direct impact on shrinkage and physical properties of the AT honeycomb product. While there is initially a non-linear response of a given property with respect to Na level, once the 0.2 wt % Na level is reached, the relationships become more linear and more predictable. Without being held to any particular theory, the results seem to indicate that Na is acting like a flux and causes enhanced sintering at the standard AT firing temperature. As a result the parts can be fired at a lower temperature for the same time or at the same temperature for a shorter time. The first choice requires less energy for the same product throughput and second choice enables a higher product throughput for the same energy expenditure.

The method according to the disclosure can also be used to control the shrinkage or growth of honeycomb ware during firing using other procedures that include:

(1) Analyzing the alkali metal content, for example, Na, in alumina and other raw materials that will be batched before they are used and making a preemptive Na adjustment. By knowing the maximum level of Na in the raw materials, sufficient Na salt or other alkali metal salt can be added to the raw materials being batched to keep the Na level constant from batch-to-batch.

(2) A preemptive Na adjustment based on predictive shrinkage modeling. Knowing that a shrinkage shift will occur due to the natural variability of the raw materials, the total alkali metal content of the batch can be adjusted by the addition of Na or other alkali metal salts or by the addition of raw materials that have a very low Na content. In this manner the Na content of a batch composition can be adjusted up or down to control shrinkage or growth during the firing stage.

Thus, in another embodiment the disclosure is directed to a method for controlling the shrinkage or growth of a honeycomb structure between a green body state and a fired state, the method comprising the steps of:
(a) analyzing the alkali metal content in alumina and other raw materials that are to be batched to form composition suitable for making a honeycomb structure,
(b) batching the analyzed alumina and other raw materials to provide an AT-forming composition suitable for making an AT honeycomb structure,
(c) adjusting the alkali metal content of the batched AT-forming composition by addition of an alkali metal salt to adjust the alkali metal content of the batched composition to a predetermined acceptable level,
(d) extruding the alkali metal adjusted batched composition into a green AT-forming honeycomb structure,
(e) measuring the dimensions (for example without limitation, the diameter of a cylindrical structure, or the major and minor axes of an oval structure) of the green structure,
(f) firing the green structure to form a fired AT honeycomb structure,
(g) measuring the dimensions (for example without limitation, the diameter of a cylindrical structure, or the major and minor axes of an oval structure) of the fired AT structure,
(h) determining the shrinkage or growth in the dimensions between the green structure and fired structure,
(i) repeating (c) to (h) as necessary to control the shrinkage or growth of the AT honeycomb between the green body and fired states.
   The alkali salt can be selected from the group consisting of Li, Na, K, Rb, Cs salts, and mixture thereof, and the anion of the alkali salt can be selected from the group consisting of chloride, bromide, iodide, bicarbonate, and carbonate, and mixtures thereof. In one embodiment the alkali salt is added to the batch an aqueous solution. In another embodiment the alkali salt is added as solid salt. In addition, an optional step can be added in which the alkali metal content of the green structure before and after firing is analyzed and compared in order to verify that the desired alkali metal content has been achieved and to provide correlation data for comparison between alkali metal analysis and the actual shrinkage or growth occurring.

The method can be used to make aluminum titanate honeycomb substrates having a selected alkali metal content that possess a number of distinct advantages. For example, the AT batch compositions in which the alkali metal content has been adjusted as described herein have well controlled shrinkage properties. As a result, the AT-forming batch compositions which have an adjusted alkali metal ion content (the alkali metal ion content having been adjusted to be in the range of 0.1 wt % to 0.6 wt % greater than that of the total alkali metal ion content present in the raw materials used to make the AT-forming batch composition, the additional 0.1 wt % to 0.6 wt % alkali metal ion being added as a selected soluble alkali metal salt as described herein to the raw materials used to make the AT-forming batch composition) can be used in the “skin former die cut” method of extruding honey comb substrates that meet stringent skin quality metrics. The “skin former die cut” has been described in commonly owned U.S. Pat. Nos. 5,089,203 and 6,455,124 B1 (Corning Incorporated) whose teaching are incorporated herein by reference, and in copending, commonly owned U.S. patent application Ser. No. 12/474,820 titled “Honeycomb Extrusion Die Apparatus and Methods,” (Corning Incorporated) whose teachings are also incorporated herein by reference. FIG. 5 herein is a copy of FIG. 4 in U.S. patent application Ser. No. 12/474,820 giving a cross sectional view of a skin forming die. As described in U.S. Ser. No. 12/474,820, Paragraph [0025], the skin slot 28 may have a width W₁ that is greater than the width W₂ of discharge slots 26. The width of W₁ of the skin slot 28 can be predetermined based on the final thickness of the skin while considering expected shrinkage of the batch material after the co-extrusion technique that allows one to co-extrude a honeycomb body and integral skin. In FIG. 5 herein the other numbers describe elements or features are as described in U.S. Ser. No. 12/474,820.

The method disclosed herein, as exemplified by the description and figures described herein, provides a number of distinct advantages for the manufacture of aluminum titanate honeycomb structures. These advantages include:
1. An understanding of the impact Na has on AT properties, the finding that the addition of an independent (non-impurity) sodium salt at a variety of levels to an AT batch composition will compensate for the natural variability in shrinkage and physical properties of AT honeycombs, and thereby reducing the total range of variability encountered in the manufacturing process.
2. A strategy to actively control variability as opposed to simply managing it.
3. Because Na is a common, variable impurity in the raw materials used in AT manufacturing, the method enables one to stabilize Na level in the final product and thus control shrinkage.
4. Controlling shrinkage as described herein enables the use of the “skin former die cut” method on extruding substrates, and thus enables the AT honeycomb manufacturer to meet stringent skin quality metrics.
5. It has further been found that the addition of an independent amount Na (an amount over the impurity level) to the AT batch composition enables an AT honeycomb manufacturer to reduce the firing cycle time and/or temperature.
6. Shrinkage control by adjustment of the Na level also provides way to meet the next generation light duty AT filter dimensional specification of ±1 mm.

It will be apparent to those skilled in the art that various modifications and variations can be made to the present disclosure without departing from the spirit and scope of the disclosure. Thus, it is intended that the present disclosure cover the modifications and variations of this disclosure provided they come within the scope of the appended claims and their equivalents.

We claim:

1. A method for controlling the shrinkage or growth of a honeycomb structure between a green body state and a fired state, the method comprising the steps of:
(a) providing an AT-forming batch composition,
(b) extruding the batch composition into a green AT-forming honeycomb structure,
(c) measuring the dimensions of the green structure,
(d) firing the green structure to form a fired AT honeycomb structure,
(e) measuring the dimensions of the fired AT structure,
(f) determining the shrinkage or growth in the dimensions between the green structure and fired structure,
(g) adjusting the alkali salt content of the AT-forming batch composition by the addition of a selected amount of a selected alkali salt to the AT-forming batch composition, and
(h) repeating (a) to (g) as necessary to control the shrinkage or growth of the AT honeycomb between the green body and fired states.

2. The method according to claim 1, wherein the alkali salt selected from the group consisting of Li, Na, K, Rb, Cs salts.

3. The method according to claim 2, wherein the anion of the alkali salt is selected from the group consisting of chloride, bromide, iodide, bicarbonate, and carbonate.

4. The method according to claim 1, wherein the alkali salt is added an aqueous solution and is selected from the group consisting of alkali metal chloride, bromide, iodide, bicarbonate, and carbonate salts.

5. The method according to claim 1, wherein the extruding of the batch composition into a green AT-forming honeycomb structure mean extruding the batch composition through a skin through a skin former die to co-form an AT honeycomb substrate having an integral skin.

6. A method for controlling the shrinkage or growth of a honeycomb structure between a green body state and a fired state, the method comprising the steps of:
(a) analyzing the alkali metal content in alumina and other raw materials that are to be batched to form composition suitable for making a honeycomb structure,
(b) batching the analyzed alumina and other raw materials to provide an AT-forming composition suitable for making an AT honeycomb structure,
(c) adjusting the alkali metal content of the batched AT-forming composition by addition of an alkali metal salt to adjust the alkali metal content of the batched composition to a predetermined acceptable level,
(d) extruding the alkali metal adjusted batched composition into a green AT-forming honeycomb structure,
(e) measuring the dimensions of the green structure,
(f) firing the green structure to form a fired AT honeycomb structure,
(g) measuring the dimensions of the fired AT structure,
(h) determining the shrinkage or growth in the dimensions between the green structure and fired structure, and
(i) repeating (c) to (h) as necessary to control the shrinkage or growth of the AT honeycomb between the green body and fired states.

7. The method according to claim 6, wherein the alkali salt selected from the group consisting of Li, Na, K, Rb, Cs salts and mixture thereof.

8. The method according to claim 7, wherein the anion of the alkali salt is selected from the group consisting of chloride, bromide, iodide, bicarbonate, and carbonate, and mixtures thereof.

9. The method according to claim 6, wherein the alkali salt is added an aqueous solution and is selected from the group consisting of alkali metal chloride, bromide, iodide, bicarbonate, and carbonate salts, and mixtures thereof.

10. The method according to claim 6, wherein the extruding of the batch composition into a green AT-forming honeycomb structure mean extruding the batch composition through a skin through a skin former die to co-form an AT honeycomb substrate having an integral skin.

11. An alumina titanate honeycomb, said honeycomb having a alkali metal ion content in the range of 0.1 wt % to 0.6 wt % greater than that of the total alkali metal ion content present in the raw materials used to make an AT-forming batch composition, the additional 0.1 wt % to 0.6 wt % alkali metal ion being an added selected soluble alkali metal salt to raw materials of the AT honeycomb forming batch composition.

12. The aluminum titanate honeycomb according to claim 11, wherein the added alkali metal salt is a sodium salt.

13. The aluminum titanate honeycomb according to claim 11, wherein the alkali metal ion content is in the range of 0.1 wt % to 0.4 wt % greater than that of the total alkali metal ion content present in the raw materials used to make the AT-forming batch composition, the additional 0.1 wt % to 0.4 wt % alkali metal ion being an added selected soluble alkali metal salt to raw materials of the AT honeycomb forming batch composition.

14. The aluminum titanate honeycomb according to claim 13, wherein the added alkali metal salt is a sodium salt.
